(19) United States
(12) Patent Application Publication
(10) Pub. No.: US 2011/0042111 A1
(43) Pub. Date: Feb. 24, 2011

(54) RIDING SOD REMOVAL MACHINE

(76) Inventor: Charles Pugh, Plant City, FL (US)

Correspondence Address: Law Office Of Lyman H. Smith, 8450 Alice Player Drive, Oak Ridge, NC, 27310, US

(21) Appl. No.: 12/859,754

(22) Filed: Aug. 19, 2010

Related U.S. Application Data
(60) Provisional application No. 61/235,262, filed on Aug. 19, 2009.

(51) Int. Cl. A01B 45/04

(52) U.S. Cl. 172/19

(57) ABSTRACT

A riding sod cutting machine may decrease the manual labor and reduce the possibility of bodily harm at home or in the work place as compared to conventional walk behind sod cutting machines. The riding sod cutting machine may result in greater productivity with less work.

### CROSS-REFERENCE TO RELATED APPLICATIONS

This application claims the benefit of priority of U.S. Provisional patent application No. 61/235,262, filed Aug. 19, 2010, the contents of which are herein incorporated by reference.

### BACKGROUND OF THE INVENTION

The present invention relates to a sod removing machine and, more particularly, to a riding sod removal machine for cutting sod away from the ground.

Typical sod cutting machines are walk behind, motorized systems that have a single blade that vibrates at a constant speed with front to back motions. These motions, due to hard hand mobility and control issues, make toes and feet dismemberment a possibility. Furthermore, typical sod cutting machines may require several hours of standing and walking to use the machines.

As can be seen, there is a need for a sod cutting machine that may decrease the manual labor and reduce the possibility of bodily harm while using the machine.

### SUMMARY OF THE INVENTION

In one aspect of the present invention, a riding sod cutting machine comprises a seat for a user to sit while operating the sod cutting machine; an engine adapted to drive the sod cutting machine; a blade adapted to be driven by the engine in a back and forth direction; and a frame adapted to position the blade at a user-selected height.

In another aspect of the present invention, a riding sod cutting machine comprises a seat for a user to sit while operating the sod cutting machine; an engine adapted to drive the sod cutting machine; a blade adapted to be driven by the engine in a back and forth direction; a one-piece A-frame adapted to position the blade at a user-selected height; and a power drive controlled by an operation control arm, wherein the blade is driven when the power drive is engaged by the operation control arm.

These and other features, aspects and advantages of the present invention will become better understood with reference to the following drawings, description and claims.

### BRIEF DESCRIPTION OF THE DRAWINGS

FIG. 1 is a perspective view of a riding sod cutting machine according to an embodiment of the present invention;

FIG. 2 is a side view of the riding sod cutting machine of FIG. 1;

FIG. 3 is a front view of the riding sod cutting machine of FIG. 1;

FIG. 4 is a rear view of the riding sod cutting machine of FIG. 1;

FIG. 5 is a top view of the front of the riding sod cutting machine of FIG. 1;

FIG. 6 is a top view of the cutting assembly of the riding sod cutting machine of FIG. 1;

FIG. 7 is a top view of the engine and transaxle of the riding sod cutting machine of FIG. 1;

FIG. 8 is a top view of a midsection of the riding sod cutting machine of FIG. 1;

FIG. 9 is a top view of a seating area of the riding sod cutting machine of FIG. 1; and

FIG. 10 is a detailed view operation control switches of the riding sod cutting machine of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a riding sod cutting machine. The riding sod cutting machine may decrease the manual labor and reduce the possibility of bodily harm at home or in the work place as compared to conventional walk behind sod cutting machines. The riding sod cutting machine may result in greater productivity with less work.

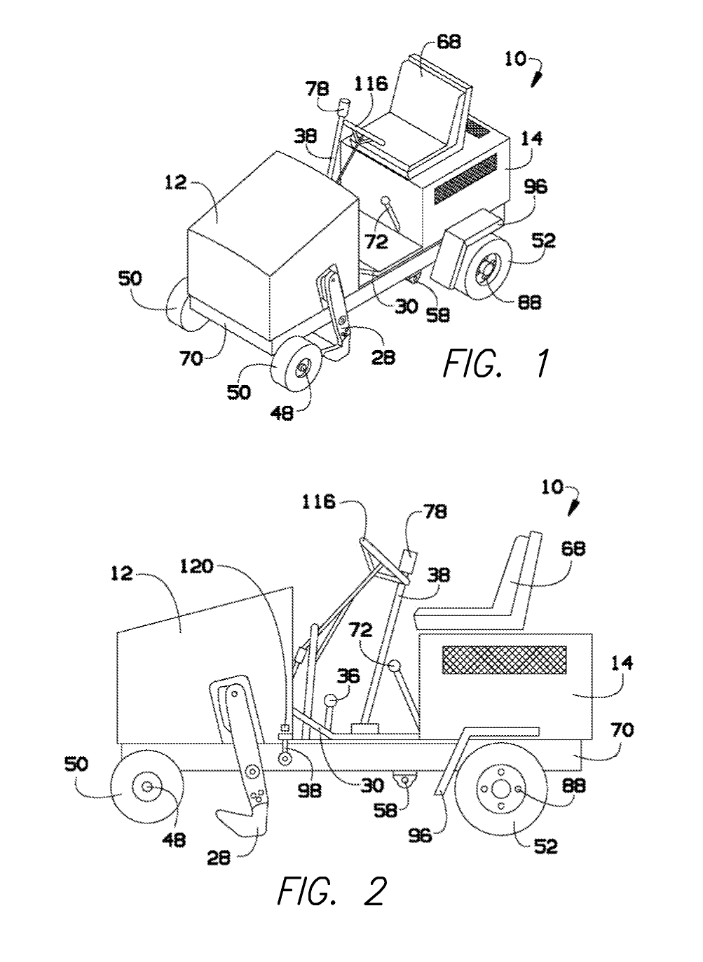

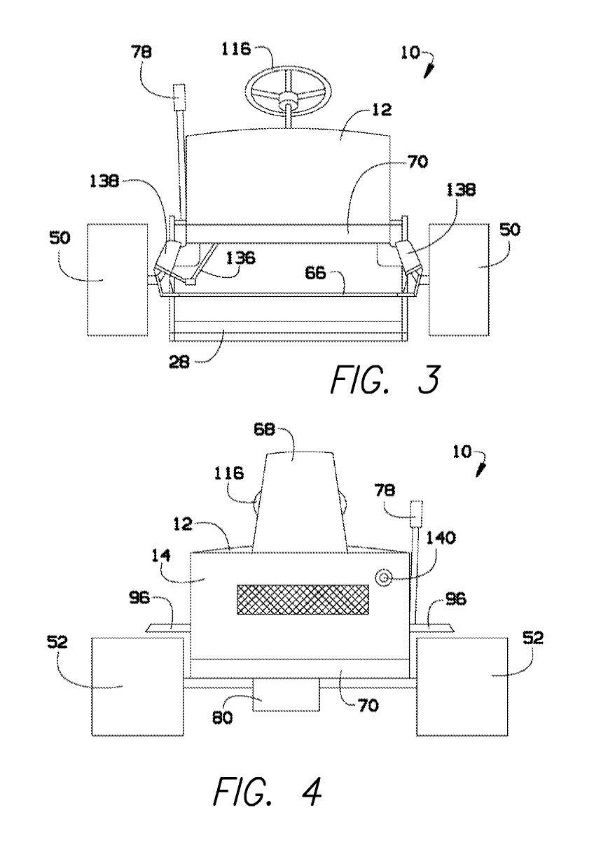

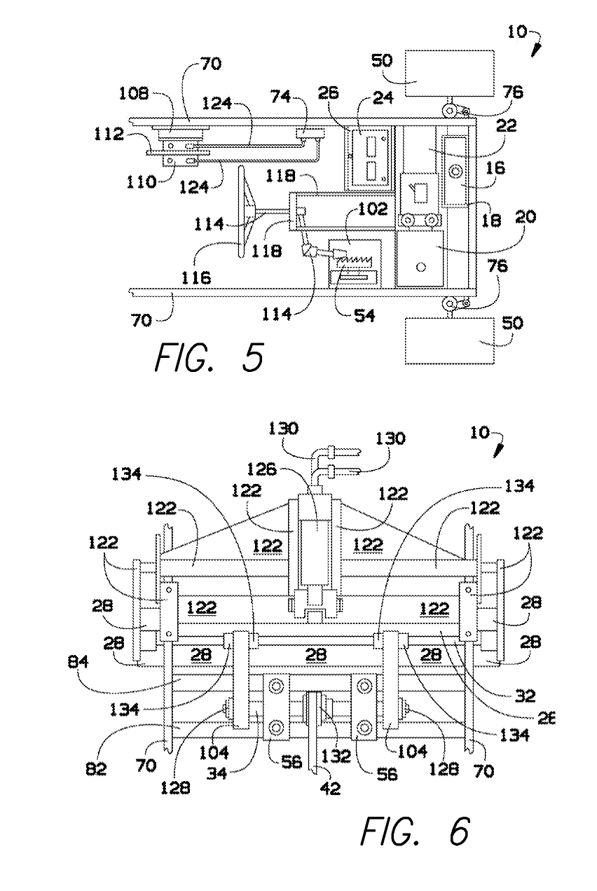

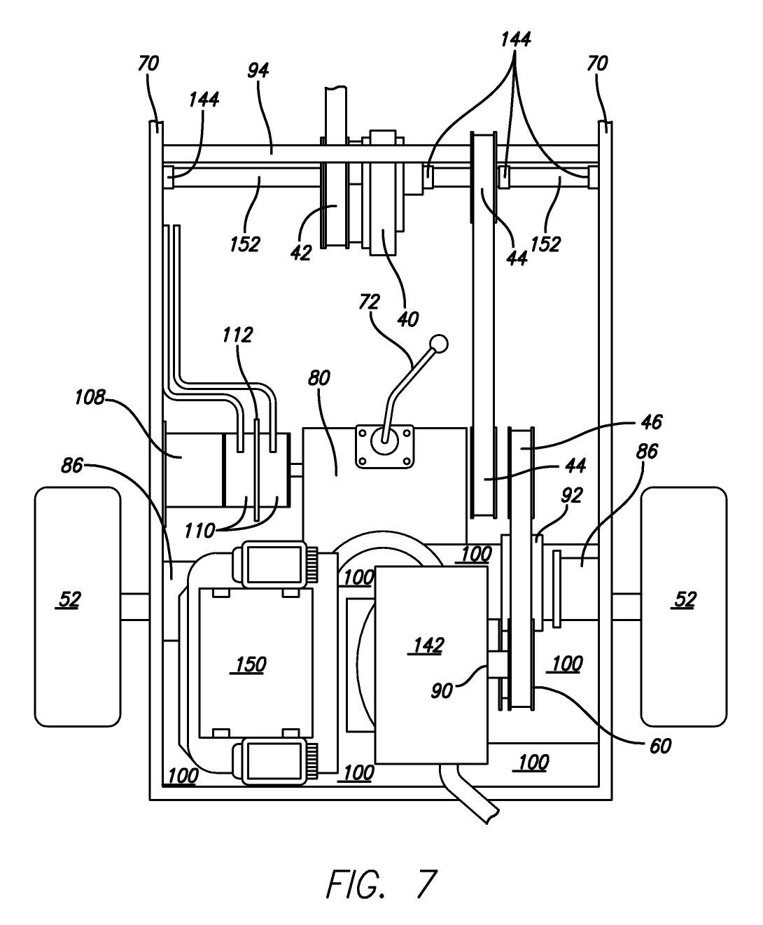

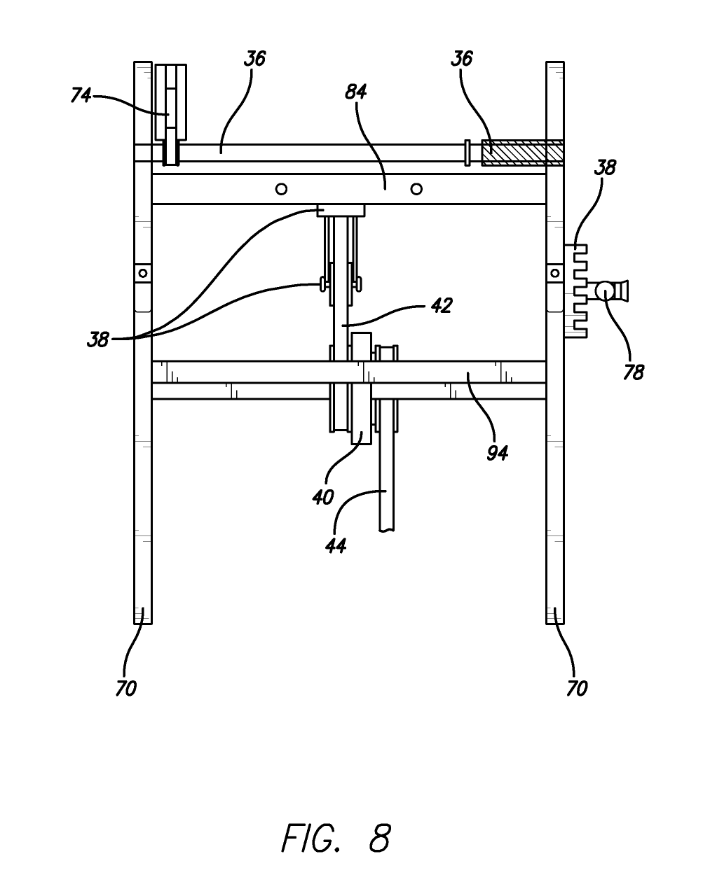

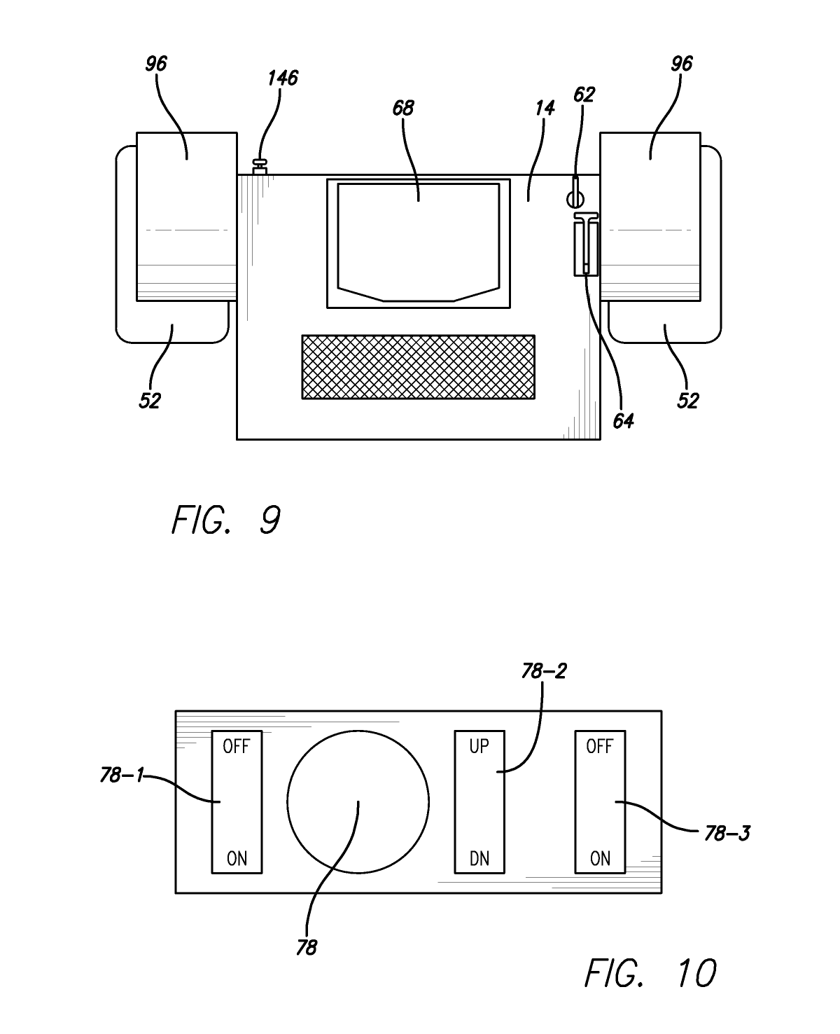

Referring to FIGS. 1 through 10, and starting at rear of a riding sod cutting machine 10, the following steps may be used to make the machine 10. An engine plate 100 may be welded to a frame 70. A transaxle 80 assembly is mounted to transaxle brackets 86 and welded flush to the inside of the frame 70. Rear wheels 52 are bolted to four-lug axle hubs 88 that connect to the transaxle shafts. The rear wheels 52 are covered with rear bolt on fenders 96.

The engine 150 bolts to the engine mounting plate 100 with four bolts. The engine exhausts out an exhaust port 140 and the exhaust and a muffler 142. An electric clutch pulley 60 is mounted on an engine output shaft 90. A primary belt 46 is installed from the engine 150 over a belt guide pulley 92 to the transaxle 80 PTO pulley. A secondary belt 44 is installed from the transaxle 80 PTO pulley to the cutting blade/power drive. An electric clutch shaft 152 is then bolted to a center support cross member 94 that is welded to the frame 70. A lock collar and bushing 144 are attached to the electric clutch shaft 152. A cutting blade belt 42 is installed from the pulley on cutting blade/power drive to the eccentric (not having its axis in the center; not having the same center) shaft pulley 132 below the belt tension lever assembly 38. The belt tension lever assembly 38 is top mounted by four bolts to the frame 70. The eccentric shaft pulley 132 is mounted pressed on the center of the eccentric shaft 34 (for converting circular into reciprocating rectilinear motion).

Two pillow blocks 56 are mounted pressed onto the eccentric shaft 34 on each side of the eccentric pulley 132, then two eccentric arms 104 are mounted pressed to the eccentric shaft 34, one outside each pillow block 56 with locking hardware 128 at both ends. The pillow blocks 56 are then bolted with two bolts each side to the front cross member 82 and two bolts to the rear cross member 84 totaling four bolts with rubber shock pads 148 between the cross members (82 and 84) and the pillow block 56.

The end of the eccentric shaft arms 104 are slid over the blade shaft 32 with lock collars 134 on each side of the shaft arms 104. This allows the shaft 32 to rotate freely. The shaft 32 extends horizontally to both lower plate bosses on the hydraulic A-frame 122. The one-piece A-frame 122 is bolted to the frame 70 with four bolts and rubber shims. The cutting blade 28 is mounted with six bolts to the lower side plates on the one-piece A-frame 122. To lower and raise the A-frame 122 and blade 28, a hydraulic lift cylinder 126 is bolted to the A-frame 122 with two bolts atop the cylinder. Hydraulic hoses 130 are fed from the self-contained unit to the cylinder 126. This function is controlled from a control arm 78. The control arm may include an engine clutch power drive switch 78-1, a raise/lower blade switch 78-2 and a cutting belt blade engage/disengage switch 78-3.

A brake pedal assembly 36 is mounted with brackets 108 sliding over the frame 70 then bolted outside, with two per side. The pedal 36 is on the right-hand side of the frame 70, and a hydraulic brake cylinder 29 is bolted to the left-hand side of the frame 70. The brake cylinder 74 has copper brake lines 124 that connect to a brake caliper 110. The brake caliper 110 is connected to the brake disc 112.

A steering column support bracket 118 is bolted to the front cross member 82 with lower support arms welded to the hydraulic mounting bracket 102 and upper support arms welded to a steering column 114 with a pressed-on steering wheel 116. The lower shaft column is connected to a steering gear assembly 54 that is mounted atop a bracket that is welded inside the frame 70. On the lower side of the gear assembly 54 is bolted a steering drag link 136. These are heim jointed and bolted to the front spindle tie rod 66, which is heim jointed and bolted to spindle both front wheels 50 mounted on spindles 138 using mounting hardware 48.

The battery compartment 26 is welded inside the frame 70 that supports the battery 24. The molded plastic gas tank 16 is mounted inside the gas tank compartment 18 welded inside the frame 70. Both the front tilt hood 12 and the rear tilt hood 14 are hinge welded to the frame 70. The front tilt hood has a hood latch catch 120 and the left and right front hood releases 98. Removable floor board panels 30 bolt to the frame 70 with two bolts on each side of the frame 70. The ignition switch 62 is along side the throttle control 64 on the operator's right side atop the rear tilt hood 14 below the seat 68. An engine choke 146 is located in a similar location on the opposite side.

The engine 150 is the power plant for the entire machine and starts with an ignition switch 62. To begin the process, one must choose a gear in the transaxle 80 to move the machine forward or reverse (with the brake 36 applied). After selecting the gear, one must switch the drive engage 78 to the “on” position to move (while releasing the foot brake 36). This will activate the drive. Once the drive is activated, this process turns power from the motor to the transaxle 80 by the primary belt 46 that in turn drives the rear wheels 52. Upon reaching the desired location to remove sod, the next step is to choose the desired cutting depth of the blade 28. There are four depth settings. This is done by the hydraulic unit 20 that is controlled by the up and down switch. When the desired height is chosen, the blade 28 will remain at this level throughout the removal process. The hydraulic unit 20 is self-contained and energized by a 12-volt battery 24. A hydraulic ram will go up or down by way of hydraulic hoses 130 that come from the hydraulic unit 20. One must throttle 64 the engine 150 up to the desired revolutions per minute. To engage the cutting blade 28, one must switch the operating control 78 to the “on” position that, in turn, energizes the electric clutch 40. The power for the electric clutch 40 is supplied from the secondary belt 44 that rotates the eccentric shaft 34 that is connected by two shaft arms 104 to the cutting blade shaft 32. The back and forth movement of the cutting blade 28 in turn cuts the root system below the sod allowing for easy removal.

The machine 10 can be assembled on an assembly line similar to an automobile. It requires machined components, after-market products, as well as prefabricated accessories. The machine 10 may require a welded steel frame 70; fabricated brackets, cross-members (82 and 84), and support plates all to be welded to the frame 70. Assembly of the machine may also require machined bosses, pressed components on shafts and bolting assembly of stationary and full range motion components. After-market products include a molded plastic fuel tank, an engine 150, a transaxle 80, a battery 24, seatbelts, tires, a steering wheel 116, pulleys, and braking components. Most components are bolted to the frame 70 for easy removal for repair or replacement.

In order to use the machine, one sits on the seat 68 of the machine 10, then starts the machine and warms the engine 150 for proper operation. Then the operator puts a foot on brake 36 and engages the transaxle 80 in the desired gear. The machine 10 is driven to the designated area where sod is to be removed. The machine 10 may be idled down, and the blade 28 is raised or lowered with the proper switch on the control arm 78. Once the blade 28 is at the desired height, the transaxle 80 may be placed in the appropriate gearing based on the turf for the best performance. Next, engage the power drive on the operation control arm; this engages the blade 28 and transaxle 80. The brake 36 may the be released slowly. The blade 28 will begin to move in a back and forth motion as machine starts to move forward. The blade 28 will locate itself under the turf below the root system as the machine 10 moves forward, cutting the roots and shaking it loose from the ground. The machine 10 may have spindle front wheels 50, so, as the steering wheel 116 is turned, the machine 10 will turn with ease and with no unnecessary jumping movement.

In alternative embodiments, the braking system can be mounted for use on left or right side and the operations control arm can be mounted on the left or right side with minor modifications.

Optional elements include addition of a hydraulic control system that would involve a hydraulic motor to power cutting blades, the power drive train and hydraulic steering. Also a hydraulic height adjustment system plumbed by hydraulic lines coming from a controlled valve body can be added. With these changes, one can control the entire operation of the machine with a hand operated lever.

It should be understood, of course, that the foregoing relates to exemplary embodiments of the invention and that modifications may be made without departing from the spirit and scope of the invention as set forth in the following claims.

What is claimed is:

1. A riding sod cutting machine comprising:
a seat for a user to sit while operating the sod cutting machine;
an engine adapted to drive the sod cutting machine;
a blade adapted to be driven by the engine in a back and forth direction; and
a frame adapted to position the blade at a user-selected height.

2. The riding sod cutting machine of claim 1, further comprising:
a power drive controlled by an operation control arm; and
a transaxle attached to gearing, wherein
the blade is driven when the transaxle is placed in a selected gearing and the power drive is engaged with the operation control arm.

3. The riding sod cutting machine of claim 1, further comprising a hydraulic lift cylinder for positioning the blade at the user selected height.

4. The riding sod cutting machine of claim 1, wherein the frame is a one-piece A-frame.

5. The riding sod cutting machine of claim 1, wherein the blade is located under the sod cutting machine, between front and back wheels thereof.

6. The riding sod cutting machine of claim 1, wherein the blade is driven by a belt driven shaft.

7. The riding sod cutting machine of claim 1, wherein the blade is driven by hydraulic power.

8. The riding sod cutting machine of claim 1, further comprising spindle front wheels.

9. The riding sod cutting machine of claim 1, further comprising a steering assembly adapted so that the user, sitting in the seat, is able to steer the sod cutting machine.

10. The riding sod cutting machine of claim 1, wherein the blade extends across at least a width of the sod cutting machine and the blade extends below a ground surface to cut away sod as the sod cutting machine is used.

11. A riding sod cutting machine comprising:
a seat for a user to sit while operating the sod cutting machine;
an engine adapted to drive the sod cutting machine;
a blade adapted to be driven by the engine in a back and forth direction;
a one-piece A-frame adapted to position the blade at a user-selected height; and
a power drive controlled by an operation control arm, wherein
the blade is driven when the power drive is engaged by the operation control arm.

12. The riding sod cutting machine of claim 11, further comprising a hydraulic lift cylinder for positioning the blade at the user selected height.

13. The riding sod cutting machine of claim 11, further comprising a steering assembly adapted so that the user, sitting in the seat, is able to steer the sod cutting machine.

14. The riding sod cutting machine of claim 11, wherein the engine is adapted to drive wheels of the machine to position the machine at a desired use position and to move the machine while the blade cuts sod.
